(19) United States
(12) Patent Application Publication
(10) Pub. No.: US 2020/0139672 A1
(43) Pub. Date: May 7, 2020

(54) DISPLAY DEVICE AND PROTECTIVE COVER WINDOW

(71) Applicant: Wuhan China Star Optoelectronics Semiconductor Display Technology Co., Ltd., Wuhan (CN)

(72) Inventor: Haoran CAO, Wuhan (CN)

(21) Appl. No.: 16/343,790

(22) PCT Filed: Nov. 1, 2018
(86) PCT No.: PCT/CN2018/113258

§ 371 Date: Apr. 22, 2019

(30) Foreign Application Priority Data
Oct. 9, 2018 (CN) 201811173854.4

(51) Int. Cl. B32B 7/12; B32B 3/26

(52) U.S. Cl. CPC B32B 7/12; H04M 1/0268; B32B 3/263

(57) ABSTRACT

The present disclosure proposes a display device and a protective cover window. The display device includes a display panel comprising a bending area and a non-bending area, an adhesive layer arranged on a surface of the display panel, and a protective cover window attached onto the display panel through the adhesive layer. The protective cover window includes a first portion and a second portion. The first portion corresponds to the non-bending area. The second portion corresponds to the bending area. A hardness of the first portion is greater than a hardness of the second portion.

### BACKGROUND

### 1. Field of the Disclosure

The present disclosure relates to the field of display technology, and more particularly, to a display device and a protective cover window.

### 2. Description of the Related Art

The size of the screen of a cellphone has now reached the limit. Screen portability and one-handed operation of 6.5 inches or more perform poorly. In order to obtain a larger display area without affecting portability and one-handed operation, the demand for a bendable cellphone becomes stronger and stronger. However, the upcoming market or related concept products are not mature enough. There are deficiencies in terms of technology and consumer recognition. The cover window of the bendable cellphone is the key factor limiting the bendable screen. An organic light-emitting diode (OLED) is equipped with good bendability, but the OLED screen also needs a cover window to protect the cover window. The cover window needs good bendability and high light transmittance, hardness of 9H or more and high strength like a cover glass of a hard-screen cellphone of the related art. At present, the flexible cover window is difficult to achieve the hardness of the cover glass, and the light transmittance of the flexible cover window fails to pass the reliability test so consumers do not recognize the flexible cover window.

The bendable cellphones that have been released on the market include two rigid liquid-crystal display (LCD) screens. The LCD screens execute bending through mechanical connection. But, there are many problems. For example, an increase of the number of screen driving integrated circuits (ICs) leads to increasing cost and power consumption. Some bezels in the bent portion cannot be eliminated completely. When a consumer uses the bendable cellphone, he/she may be satisfied. The screen of the bendable cellphone is difficult to bend inward, and the bending angle is limited by the mechanical structure. After the cellphone is bent, the thickness of the whole module greatly increases, resulting in poor portability. Further, another flexible screen can be bent in the related art. The thickness of the cellphone and the cost of portability are better than the former. However, there are also many problems. For example, the hardness of the cover window is not enough. It is difficult to pass the reliability test. Wrinkles easily occur in the cover window area after bending. Accordingly, mass production is not yet available to consumers.

Therefore, the related art has some shortcomings and needs to be solved urgently.

### SUMMARY

The present embodiment proposes a display device and a protective cover window. The embodiment of the present embodiment reduces the number of driving integrated circuits (ICs), power consumption, and the thickness of the device. Besides, the display device and the protective cover window provided by the present embodiment have good bending characteristics, hardness, and light transmittance, and can pass the reliability test.

According to a first aspect of the present disclosure, a display device includes a display panel comprising a bending area and a non-bending area, an adhesive layer arranged on a surface of the display panel, and a protective cover window attached onto the display panel through the adhesive layer. The protective cover window includes a first portion and a second portion. The first portion corresponds to the non-bending area. The second portion corresponds to the bending area. A hardness of the first portion is greater than a hardness of the second portion. A contact surface between the second portion and the first portion is inclined at a predetermined angle.

According to an embodiment of the present disclosure, the first portion of the protective cover window is a cover glass portion. The cover glass portion is arranged at two terminals of the protective cover window. The second portion is a base film portion. The base film portion is arranged between two of the adjacent cover glass portions.

According to an embodiment of the present disclosure, the cross-sectional shape of the base film portion is trapezoidal. An angle of the contact surface between the base film portion and the cover glass portion and a plane where the protective cover window is arranged ranges from 10 degrees to 80 degrees.

According to an embodiment of the present disclosure, the base film portion comprises a base film layer which is formed and layered by two or more layers connected with a supporting component.

According to an embodiment of the present disclosure, the base film portion comprises two or more of the base film layers. A gap layer is formed between two of the adjacent base film layers and configured to store a compressed base film when the cover window is bent. The gap layer is provided with the supporting component spaced apart to support two of the adjacent base film layers.

According to an embodiment of the present disclosure, the width of the base film layer outward from a side close to the display panel is gradually reduced.

According to an embodiment of the present disclosure, the thickness of the base film layer from a side away from the display panel becomes gradually greater.

According to a second aspect of the present disclosure, a protective cover window includes a cover glass portion and a base film portion. The cover glass portion corresponds to a non-bending area of the protective cover window and is arranged at two terminals of the protective cover window. The base film portion corresponds to a bending area of the protective cover window and is arranged between two of the adjacent cover glass portions. The hardness of the cover glass portion is greater than the hardness of the base film portion. A contact surface between the base film portion and the cover glass portion is inclined at a predetermined angle. The base film portion comprises a base film layer which is formed and layered by two or more layers connected with a supporting component.

According to an embodiment of the present disclosure, the base film portion comprises two or more of the base film layers. A gap layer is formed between two of the adjacent base film layers and configured to store a compressed base film when the cover window is bent. The gap layer is provided with the supporting component spaced apart to support two of the adjacent base film layers.

According to an embodiment of the present disclosure, the supporting component between two of the adjacent base film layers is a supporting column. The supporting columns are arranged parallel to each other or arranged in a zigzag manner. The base film layer and the supporting component are both fabricated by transparent material.

According to an embodiment of the present disclosure, the cross-sectional shape of the base film portion is trapezoidal. An angle of the contact surface between the base film portion and the cover glass portion and a plane where the protective cover window is arranged ranges from 10 degrees to 80 degrees.

According to a third aspect of the present disclosure, a display device includes a display panel comprising a bending area and a non-bending area, an adhesive layer arranged on a surface of the display panel, and a protective cover window attached onto the display panel through the adhesive layer. The protective cover window includes a first portion and a second portion. The first portion corresponds to the non-bending area. The second portion corresponds to the bending area. A hardness of the first portion is greater than a hardness of the second portion. A contact surface between the second portion and the first portion is inclined at a predetermined angle.

According to an embodiment of the present disclosure, the first portion of the protective cover window is a cover glass portion. The cover glass portion is arranged at two terminals of the protective cover window. The second portion is a base film portion. The base film portion is arranged between two of the adjacent cover glass portions.

According to an embodiment of the present disclosure, the cross-sectional shape of the base film portion is trapezoidal. An angle of the contact surface between the base film portion and the cover glass portion and a plane where the protective cover window is arranged ranges from 10 degrees to 80 degrees.

According to an embodiment of the present disclosure, the base film portion comprises a base film layer which is formed and layered by two or more layers connected with a supporting component.

According to an embodiment of the present disclosure, the base film portion comprises two or more of the base film layers. A gap layer is formed between two of the adjacent base film layers and configured to store a compressed base film when the cover window is bent. The gap layer is provided with the supporting component spaced apart to support two of the adjacent base film layers.

According to an embodiment of the present disclosure, the width of the base film layer outward from a side close to the display panel is gradually reduced.

According to an embodiment of the present disclosure, the thickness of the base film layer from a side away from the display panel becomes gradually greater.

According to an embodiment of the present disclosure, the supporting component between two of the adjacent base film layers is a supporting column. The supporting columns are arranged parallel to each other or arranged in a zigzag manner.

According to an embodiment of the present disclosure, the base film layer and the supporting component are both fabricated by transparent material.

The beneficial effects of the present embodiment are as follows. The display device and the protective cover window of the present embodiment form a flexible bending protective cover window by combining a colorless base film (CPI) structure and a cover window glass. The base film structure includes a plurality of base films inside. The base films of different film layers form a gap between supporting components. The multi-film layer structure can avoid the formation of wrinkles in the bending area while ensuring good flexibility. The flexible protective cover window has the hardness, light transmittance, good touch, and good appearance of the cover glass. At the same time, the flexible design in the bending area will ensure the bending ability of the flexible display device, and it is easier to make the product than the cover window of the full-face flexible CPI to be launched on the market. Compared with the method of realizing a bendable display device by mechanical connection including two LCD screens or two rigid screens, power consumption can be reduced, the number of driving ICs can be reduced, and the thickness of the whole machine can be reduced, thereby achieving higher practicality and business value.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, those of ordinary skill in this field can obtain other figures according to these figures without paying the premise.

FIG. 1 illustrates a schematic diagram of a display device of the related art.

FIG. 2 illustrates a schematic diagram of a display device according to an embodiment of the present disclosure.

FIG. 3 illustrates a schematic diagram of the protective cover window of the display device according to the embodiment of the present disclosure.

FIG. 4 illustrates a schematic diagram of a base film portion according to the embodiment of the present disclosure.

FIG. 5 illustrates a schematic diagram of bending of a display device according to the embodiment of the present disclosure.

### DETAILED DESCRIPTION OF THE EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

An object of the present embodiment is to solve the problems occurring to a bendable display device of the related art. The problems of the related art are the original hardness of the bendable display device, poor light transmittance, poor bending performance, and more driving integrated circuits (ICs) than necessary, which results in an increase in power consumption. Besides, the thicker the whole device is, the harder the device becomes to carry. The present embodiment can overcome these defects.

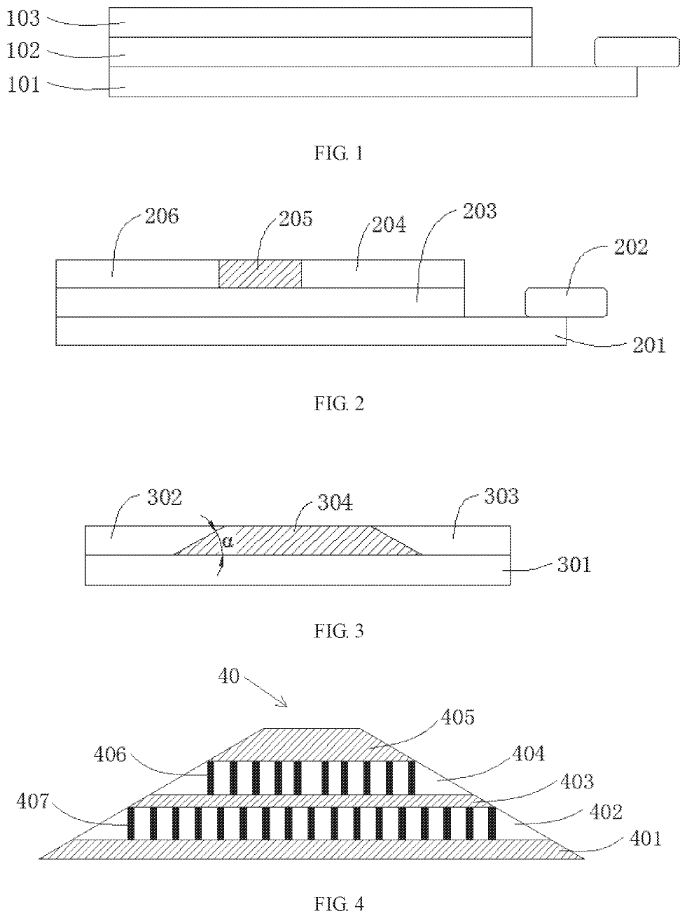

Please refer to FIG. 1 illustrating a schematic diagram of a display device of the related art. A cover window 103 is attached to a display panel 101 through an optically clear adhesive (OCA) adhesive layer 102. The main structure of the cover window 103 is a hard coating coated on a base film that is generally made of colorless polyimide (CPI). The cover window 103 thus obtained can only be adopted for exhibitions and the like due to the limitation of current materials and the amount of products that cannot be applied. The hardness of the cover window 103 is much lower than that of a cover glass and fails to pass the reliability test. Besides, compared with the sense of surface touch, light transmittance, appearance, and the like, the cover window 103 is inferior to the cover glass.

Please refer to FIG. 2 illustrating a schematic diagram of a display device according to an embodiment of the present disclosure. The display device includes a display panel 201, an adhesive layer 203, and a protective cover window. The display panel 201 includes a bending area and a non-bending area. The adhesive layer 203 is formed on the surface of the display panel 201. The protective cover window is attached to the display panel 201 through the adhesive layer 203. The hardness of a first cover window of the protective cover window corresponding to the non-bending area is greater than a hardness of the second portion corresponding to the bending area. In another embodiment, a first portion of a protective cover window is a cover glass portion. A second portion is a base film portion 205. The cover glass portion includes a first cover glass portion 204 and a second cover glass portion 206. The base film portion 205, the first cover window glass portion 204, and the second cover window glass portion 206 are arranged as the same layer. The first cover glass portion 204 and the second cover glass portion 206 are connected to the two opposite sides of the base film portion 205, respectively. The thickness of the base film portion 205 is the same as the thickness of the first cover glass portion 204 and the thickness of the second cover glass portion 206. In another embodiment, the thickness is about 400 micrometer (μm). The non-display area at the edge of the display panel 201 is provided with a DIC chip. The base film portion 205 is taken as an example only in the present embodiment. It can be understood that the display device of the present embodiment may include the plurality of base film portions 205. The plurality of base film portions 205 may be arranged in parallel or in a cross. Besides, the plurality of base film portions 205 are connected to corresponding cover glass portions, which is not limited here.

Please refer to FIG. 3 illustrating a schematic diagram of the protective cover window of the display device according to the embodiment of the present disclosure. The protective cover window is attached onto an adhesive layer 301. The contact surface between a base film portion 304 and a first cover glass portion 302 is inclined at a predetermined angle. The contact surface between the base film portion 304 and a second cover glass portion 303 is inclined at a predetermined angle. In this way, the contact areas between the base film portion 304 and the first cover glass portion 302 and between the base film portion 304 and the second cover glass portion 303 increase. A contact angle of the contact surface between the base film portion 304 and the first cover glass portion 302 and a plane where the protective cover window is arranged ranges from 10 degrees to 80 degrees (10° to 80°). A contact angle of the contact surface between the base film portion 304 and the second cover glass portion 303 and the plane where the protective cover window is arranged ranges from 10° to 80°. In another embodiment, a contact angle α is 30°. The cross-sectional shape of a base film portion 304 is trapezoidal, rectangular, etc. In another embodiment, the cross-sectional shape of a base film portion 304 is trapezoidal.

Please refer to FIG. 4 illustrating a schematic diagram of a base film portion 40 according to the embodiment of the present disclosure. The base film portion 40 includes a base film layer which is formed and layered by two or more layers connected with a supporting component. A gap layer is formed between two of the adjacent base film layers and supported with the supporting component and configured to store the compressed base film upon bending. The base film portion 40 includes, in order from the side close to the display panel, a first base film layer 401, a first gap layer 402, a second base film layer 403, a second gap layer 404, and a third base film layer 405. The first gap layer 402 is formed between the first base film layer 401 and the second base film layer 403. The first supporting components 407 are disposed in the first gap layer 402 at intervals and configured to support the first base film layer 401 and the second base film layer 403 to maintain a certain gap between two of the adjacent base film layers. In this way, the compressed portion of the base film layer can be temporarily stored in the gap layer to avoid wrinkles generated on the surface of the protective cover window when the display device is bent. The second base film layer 403 and the third base film layer 405 are supported with a second supporting component 406. Such design is also adopted in the same manner.

In this embodiment, the base film layer is made of PI film material and has strong bending ability and excellent recovering ability after stretching. The base film layer may aggregate or be stretched when bent. For example, after a plane of the display device is bent, the first base film layer 401 (inner layer) is compressed so as to be partially squeezed into the first gap layer 402 while the third base film layer 405 (outer layer) is stretched. The portion of the base film layer that is compressed enters the gap layer during a complete bending opening process.

In another embodiment, a supporting component between two adjacent gap layers are misaligned to avoid affecting the bending radius of a display device due to the supporting force of the two supporting components which are arranged opposite to each other.

In another embodiment, the width of a base film layer outward from the side close to a display panel is gradually reduced. In another embodiment, the opposite design or other structural design may be adopted, and no limitation is imposed here.

In another embodiment, the thickness of a base film layer from the side away from a display panel is greatest. The base film layer from the side away from the display panel is stretched when the base film layer is bent in the embodiment. Therefore, it is ensured that there is sufficient thickness for the base film layer to be stretched and extended.

In another embodiment, a supporting component between two adjacent base film layers is a supporting column. The supporting columns are arranged parallel to each other or arranged in a zigzag manner. The base film layer and the supporting component are both fabricated by transparent material.

In the present embodiment, only one of the structures of the base film portion is demonstrated. If the bending property or the like is considered, the number of layers for the gap layer can be increased. Theoretically, the more the number of layers are, the more capable the bending ability is.

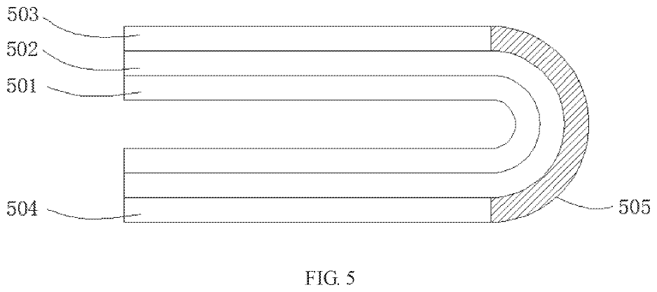

Please refer to FIG. 5 illustrating a schematic diagram of bending of a display device according to the embodiment of the present disclosure. The display device includes a display panel 501, an adhesive layer 502, and a protective cover window. The adhesive layer 502 is arranged on the display panel 501. The protective cover window is attached to the adhesive layer 502. The protective cover window includes a base film portion 505, a first cover window glass portion 503, and a second cover window glass portion 504. The first cover window glass portion 503 and the second cover window glass portion 504 are arranged on opposite sides of the base film portion 505. When the display device is bent into the shape of the display panel 501 on the inner side, the outer side of the base film portion 505 is subjected to a tensile force, and the inner side of the base film portion 505 is subjected to a compressive force. However, since the structure of the inside of the base film portion 505 is a multi-film layer in which the base film layer is spaced apart from the gap layer, the base film layer on the compressed side can enter the gap layer, thereby avoiding wrinkles at the bending with good bending performance. Most of the area is covered with the cover glass so better hardness and good light transmission performance are obtained.

The present disclosure further includes a protective cover window. The protective cover window includes a base film portion and a cover glass portion. The base film portion corresponds to the bending area of the protective cover window. The cover glass portion corresponds to a non-bending area of the protective cover window. The contact surface of the base film portion and the adjacent cover glass portion is inclined at a predetermined angle. The base film portion includes two or more layers of a base film layer connected by a supporting component. The base film portion includes two or more base film layers. A gap layer is formed between two adjacent base film layers and configured to store the compressed base film when the cover window is bent. The gap layer is provided with the supporting component spaced apart to support two of the adjacent base film layers. For the specific structure of the protective cover window, please refer to the description in the foregoing embodiment. The details will not be repeated. The display device and the protective cover window of the present embodiment form a flexible bending protective cover window by combining a colorless base film structure and a cover window glass. The base film structure includes a plurality of base films inside. The base films of different film layers form a gap between supporting components. The multi-film layer structure can avoid the formation of wrinkles in the bending area while ensuring good flexibility. The flexible protective cover window has the hardness, light transmittance, good touch, and good appearance of the cover glass. At the same time, the flexible design in the bending area will ensure the bending ability of the flexible display device, and it is easier to make the product than the cover window of the full-face flexible CPI to be launched on the market. Compared with the method of realizing a bendable display device by mechanical connection including two LCD screens or two rigid screens, power consumption can be reduced, the number of driving ICs can be reduced, and the thickness of the whole machine can be reduced, thereby achieving higher practicality and business value.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A display device, comprising:
a display panel, the display panel comprising a bending area and a non-bending area;
an adhesive layer, arranged on a surface of the display panel;
a protective cover window, attached onto the display panel through the adhesive layer;
wherein the protective cover window comprises a first portion and a second portion; the first portion corresponds to the non-bending area; the second portion corresponds to the bending area; a hardness of the first portion is greater than a hardness of the second portion; a contact surface between the second portion and the first portion is inclined at a predetermined angle.

2. The display device of claim 1, wherein the first portion of the protective cover window is a cover glass portion; the cover glass portion is arranged at two terminals of the protective cover window; the second portion is a base film portion; the base film portion is arranged between two of the adjacent cover glass portions.

3. The display device of claim 2, wherein the cross-sectional shape of the base film portion is trapezoidal; an angle of the contact surface between the base film portion and the cover glass portion and a plane where the protective cover window is arranged ranges from 10 degrees to 80 degrees.

4. The display device of claim 2, wherein the base film portion comprises a base film layer which is formed and layered by two or more layers connected with a supporting component.

5. The display device of claim 4, wherein the base film portion comprises two or more of the base film layers; a gap layer is formed between two of the adjacent base film layers and configured to store a compressed base film when the cover window is bent; the gap layer is provided with the supporting component spaced apart to support two of the adjacent base film layers.

6. The display device of claim 5, wherein the width of the base film layer outward from a side close to the display panel is gradually reduced.

7. The display device of claim 5, wherein the thickness of the base film layer from a side away from the display panel becomes gradually greater.

8. A protective cover window, comprising:
a cover glass portion, corresponding to a non-bending area of the protective cover window and arranged at two terminals of the protective cover window;
a base film portion, corresponding to a bending area of the protective cover window and arranged between two of the adjacent cover glass portions;
wherein the hardness of the cover glass portion is greater than the hardness of the base film portion; a contact surface between the base film portion and the cover glass portion is inclined at a predetermined angle; the base film portion comprises a base film layer which is formed and layered by two or more layers connected with a supporting component.

9. The protective cover window of claim 8, wherein the base film portion comprises two or more of the base film layers; a gap layer is formed between two of the adjacent base film layers and configured to store a compressed base film when the cover window is bent; the gap layer is provided with the supporting component spaced apart to support two of the adjacent base film layers.

10. The protective cover window of claim 8, wherein the supporting component between two of the adjacent base film layers is a supporting column; the supporting columns are arranged parallel to each other or arranged in a zigzag manner; the base film layer and the supporting component are both fabricated by transparent material.

11. The protective cover window of claim 8, wherein the cross-sectional shape of the base film portion is trapezoidal; an angle of the contact surface between the base film portion and the cover glass portion and a plane where the protective cover window is arranged ranges from 10 degrees to 80 degrees.

12. A display device comprising:
a display panel, comprising a bending area and a non-bending area;
an adhesive layer, arranged on a surface of the display panel;
a protective cover window, attached onto the display panel through the adhesive layer;
wherein the protective cover window comprises a first portion and a second portion; the first portion corresponds to the non-bending area; the second portion corresponds to the bending area; a hardness of the first portion is greater than a hardness of the second portion.

13. The display device of claim 12, wherein the first portion of the protective cover window is a cover glass portion; the cover glass portion is arranged at two terminals of the protective cover window; the second portion is a base film portion; the base film portion is arranged between two of the adjacent cover glass portions.

14. The display device of claim 13, wherein the cross-sectional shape of the base film portion is trapezoidal; an angle of the contact surface between the base film portion and the cover glass portion and a plane where the protective cover window is arranged ranges from 10 degrees to 80 degrees.

15. The display device of claim 13, wherein the base film portion comprises a base film layer which is formed and layered by two or more layers connected with a supporting component.

16. The display device of claim 15, wherein the base film portion comprises two or more of the base film layers; a gap layer is formed between two of the adjacent base film layers and configured to store a compressed base film when the cover window is bent; the gap layer is provided with the supporting component spaced apart to support two of the adjacent base film layers.

17. The display device of claim 16, wherein the width of the base film layer outward from a side close to the display panel is gradually reduced.

18. The display device of claim 16, wherein the thickness of the base film layer from a side away from the display panel becomes gradually greater.

19. The display device of claim 15, wherein the supporting component between two of the adjacent base film layers is a supporting column; the supporting columns are arranged parallel to each other or arranged in a zigzag manner.

20. The display device of claim 15, wherein the base film layer and the supporting component are both fabricated by transparent material.
